(19) United States
(12) Patent Application Publication
(10) Pub. No.: US 2006/0252434 A1
(43) Pub. Date: Nov. 9, 2006

(54) Mobile communication device with e-map data, a phone book, and wireless communication, and an application method thereof

(76) Inventor: Bing-Sheng Lin, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/124,040

(22) Filed: May 9, 2005

(51) Int. Cl. H04Q 7/20

(52) U.S. Cl. 455/456.5; 455/419; 455/414.1

(57) ABSTRACT

The present invention describes a mobile communication device with e-map data, a phone book and wireless communication, and an application method thereof. The mobile communication device uses integrated e-map data, a phone book, and wireless communication capabilities to display point-of-interest information on said device or to transfer said point-of-interest information to another mobile communication device through wireless transmission to implement a data query and data sharing function, thereby supplementing capabilities found in prior-art mobile communication devices.

### BACKGROUND OF THE INVENTION

1. Field of the Invention

The present invention discloses a mobile communication device with e-map data, a phone book, and wireless communication, and an application method thereof, allowing the mobile communication device to include e-map data, the phone book and the wireless communication capabilities to provide more convenience for the user.

2. Description of the Related Art

Nowadays people search the yellow pages, browse the internet or call telephone directory service to find a phone number of a shop, a tourist spots or an organization, and the query result must be written down on a note or memorized by a user for further dialing purpose.

A mobile phone has virtually become a necessity in everyday life, and a mobile phone can provide additional functions, such as working with a GPS module to provide real time and consistently updated digital data for a position, or using wireless network transmission interface to enable communication among different mobile phones.

Taiwan patent publication No. 200406592, entitled, “A mobile communication device capable of positioning and real-time display of positioning information and a method thereof”, discloses a GPS communication module externally connected to a mobile phone. GPS data are displayed on the mobile phone screen, while an electronic map of the present location of the mobile phone is obtained from a carrier and displayed on the mobile phone screen.

Moreover, Taiwan patent issued No. 535115, entitled, “A mobile communication device”, discloses a mobile communication device used by a person or located in a vehicle operating in operation anywhere to exchange specific data with a moving or motionless vehicle, enabling verification of the specific communication of every vehicle from a farther distance.

Furthermore, Taiwan patent issued No. 1220720, entitled, “Simple map and data query system”, discloses a simple map and data query system having a hierarchy menu for users to search by layer, or to jump search the content, to reduce greatly the complexity of the operating interface and the time taken in a map or data query.

Although the above-mentioned prior arts provide various advantages and features to the users, however, their functions tend to be simple.

### SUMMARY OF THE INVENTION

In order to provide maximum convenience to users, the present invention discloses a mobile communication device with e-map data, a phone book, and wireless communication, and an application method thereof, allowing the mobile communication device to maximize its benefits.

The object of the present invention is to enable mobile communication devices to combine functions of e-map data, a phone book and wireless communication to provide maximum convenience to users.

Therefore, the present invention discloses an application method for a mobile communication device with e-map data, comprising: displaying a data display interface; receiving query data; calling a e-map data query engine unit to request the e-map data by using the query data; returning a query result and displaying the same on a human-machine data processing interface unit; and executing a command input by a user through the human-machine data processing interface unit.

Also, the present invention discloses a mobile communication device with e-map data, comprising: e-map data; an e-map data query engine unit for receiving query data to search the e-map data; and a human-machine data processing interface unit for connecting the e-map data query engine unit to display a query result.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a diagram illustrating an inner structure of the mobile communication device in the present invention;

FIG. 2 is a diagram illustrating the mobile communication device in the present invention;

FIG. 3 is a flow chart illustrating an application method of the present invention;

FIG. 4 is a flow chart illustrating a phone book application of the present invention;

FIG. 5 is a flow chart illustrating how the mobile communication device integrating e-map data works to receive e-map data; and

FIG. 6 is a flow chart illustrating how the mobile communication device having no integrated e-map data works to receive e-map data.

### DETAILED DESCRIPTION OF PREFERRED EMBODIMENTS

In order to better explain the skills, methods and efforts taken in implementing the objects of the present invention, reference is made to the following detailed description and the appended drawings. The appended drawings, however, are for reference and descriptive purpose only, and are not intended to limit the present invention.

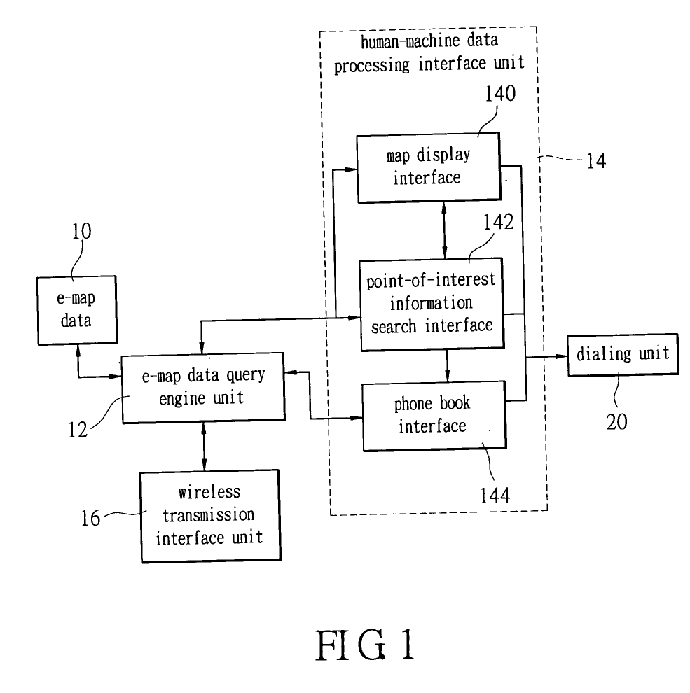

FIG. 1 is a diagram illustrating an inner structure of the mobile communication device in the present invention. The mobile communication device disclosed in the present invention is a mobile phone or a PDA (personal data assistant), comprising e-map data 10, e-map data query engine unit 12, a human-machine data processing interface unit 14, a wireless transmission interface unit 16 and a dialing unit 20. The e-map data 10 stores numerical geospatial data and the point-of-interest (POI) information comprising phone numbers, addresses, and geospatial data. The e-map data query engine unit 12 connects to the e-map data 10 for processing messages from POI search and map query, map portraying, and POI information query.

The human-machine data processing interface unit 14 connects to the e-map data query engine unit 12. The human-machine data processing interface unit 14 comprises a map display interface 140, a point-of-interest search information interface 142 and a phone book interface 144. The map display interface 140 is used for displaying maps. The point-of-interest search interface 142 is for POI information input/output. The phone book interface 144 is for storing names, phone numbers and addresses. The wireless transmission interface unit 16 (such as Bluetooth, Wi-Fi) connects to other mobile communication device for connection and data transfer. The dialing unit 20 connects to the map display interface 140, the point-of-interest information search interface 142 and the phone book interface 144 for data input.

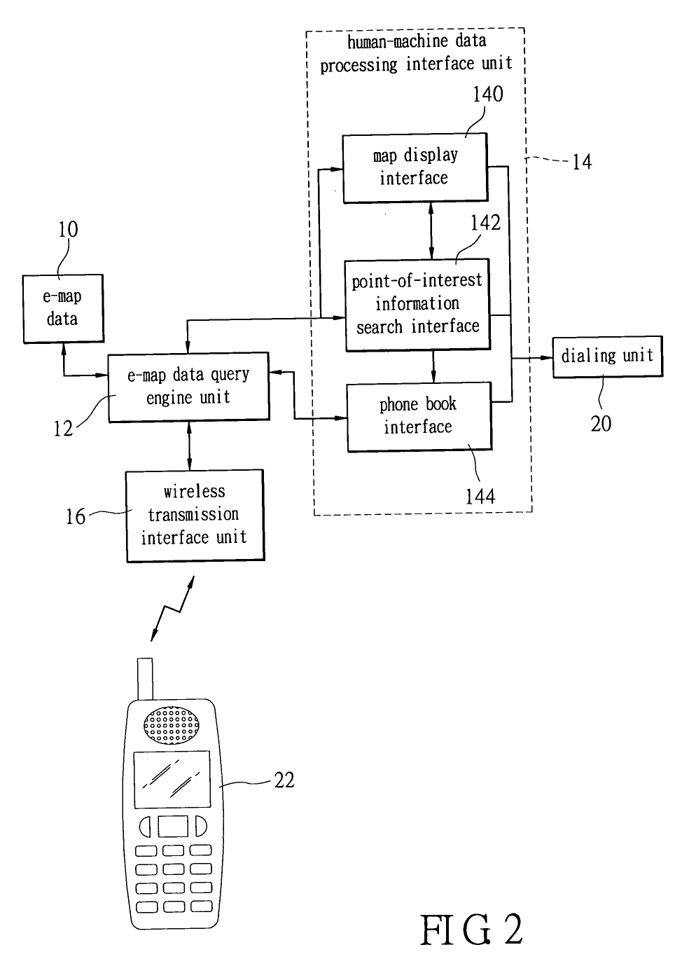

FIG. 2 is a diagram illustrating the mobile communication device in the present invention. The diagram shows the wireless interconnecting structure used by the mobile communication device in the present invention to communicate with other mobile communication devices. The mobile communication device disclosed in the present invention comprises the e-map data 10, the e-map data query engine unit 12, the human-machine data processing interface unit 14, the wireless transmission interface unit 16 and the dialing unit 20. The e-map data 10 stores numerical geospatial data and the point-of-interest (POI) information, comprising phone numbers, addresses, and geospatial data. The e-map data query engine unit 12 connects to the e-map data 10 for processing messages from POI searches, map queries, map portraying, and POI information queries.

The human-machine data processing interface unit 14 connects to the e-map data query engine unit 12. The human-machine data processing interface unit 14 comprises a map display interface 140, a point-of-interest information search interface 142, and a phone book interface 144. The map display interface 140 is used for displaying maps. The point-of-interest information search interface 142 is for POI information input/output. The phone book interface 144 is for storing contacts, phone numbers and addresses. The wireless transmission interface unit 16 (such as Bluetooth, Wi-Fi) connects to other mobile communication device for connection and data transfer. The dialing unit 20 connects to the map display interface 140, the point-of-interest information search interface 142 and the phone book interface 144 for data input.

In FIG. 2, the other mobile communication device is a mobile phone, which can be a mobile communication device having integrated e-map data or a mobile communication device having no integrated e-map data.

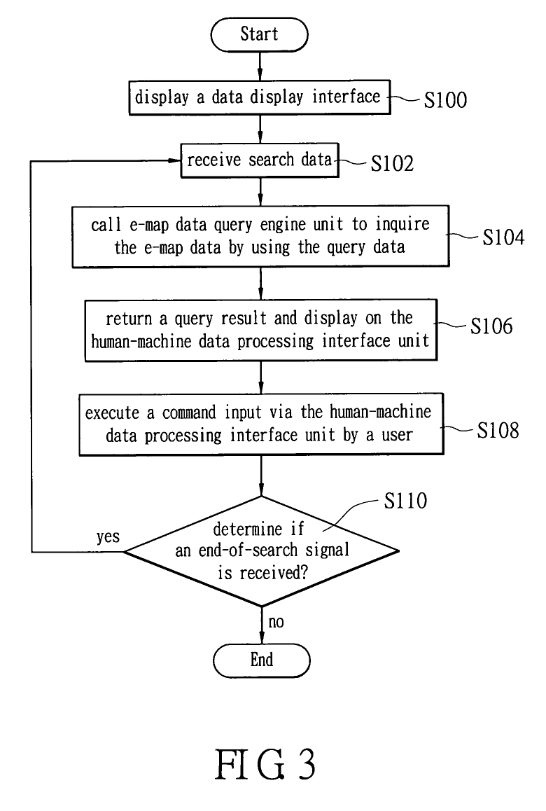

FIG. 3 is a flow chart illustrating an application method of the mobile communication device with e-map data, a phone book and wireless communication disclosed in the present invention. In step S100, a data display interface is displayed. In step S102, query data are received. The query data are input by a user via the human-machine data processing interface unit.

In step S104, a e-map data query engine unit is called to request the e-map data by using the query data. The e-map data query engine unit comprises an electronic map engine and a point-of-interest information engine, and the e-map data comprises an electronic map and a point-of-interest information. In step S106, a query result is returned and displayed on the human-machine data processing interface unit. The query result is a text, a point-of-interest information, a map graph or a combination thereof. In step S108, a command input by a user is sent via the human-machine data processing interface unit. The command comprises importing the text or the point-of-interest information into a personal phone book, transferring the text or the point-of-interest information to a dialing unit for dialing, using a wireless communication scheme to transmit the query results to other mobile communication devices, or a combination thereof. The personal phone book is included in the human-machine data processing interface unit, while the wireless transmission scheme transmits via SMS/MMS, infrared, Bluetooth or wireless local area network.

In step S110, whether an end-of-search signal is received is determined. If the end-of-search signal is received, then the search is terminated. If not, the process returns to the receiving step S102.

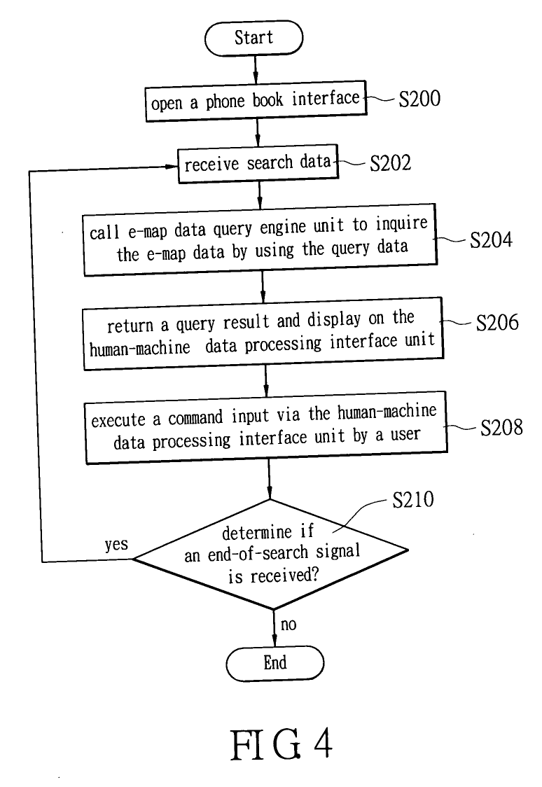

FIG. 4 is a flow chart illustrating a phone book application of the present invention. The phone book application flow chart comprises the following steps. In step 200, a phone book interface is initiated. In step S202, query data are received. The query data are input by a user via the human-machine data processing interface unit. In step S204, an e-map data query engine unit is called to request the e-map data by using the query data. The e-map data query engine unit comprises an electronic map engine and a point-of-interest information engine, and the e-map data comprises an electronic map and point-of-interest information.

In step S206, a query result is returned and displayed on the human-machine data processing interface unit. The query result is a text, point-of-interest information, a map, or a combination thereof. In step S208, a command input by a user via the human-machine data processing interface unit is executed. The command comprises importing the text or the point-of-interest information into a personal phone book, transferring the text or the point-of-interest information to a dialing unit for dialing, using a wireless communication interface to share the query results with other mobile communication devices, or a combination thereof. The personal phone book is included in the human-machine data processing interface unit, with the dialing unit being a keyboard implemented on the mobile communication device, and the wireless transmission interface being SMS/MMS, infrared, Bluetooth or wireless local area network. In step S210, whether an end-of-search signal is received is determined. If the end-of-search signal is received, then the search terminates. If not, the process then returns to opening step S200.

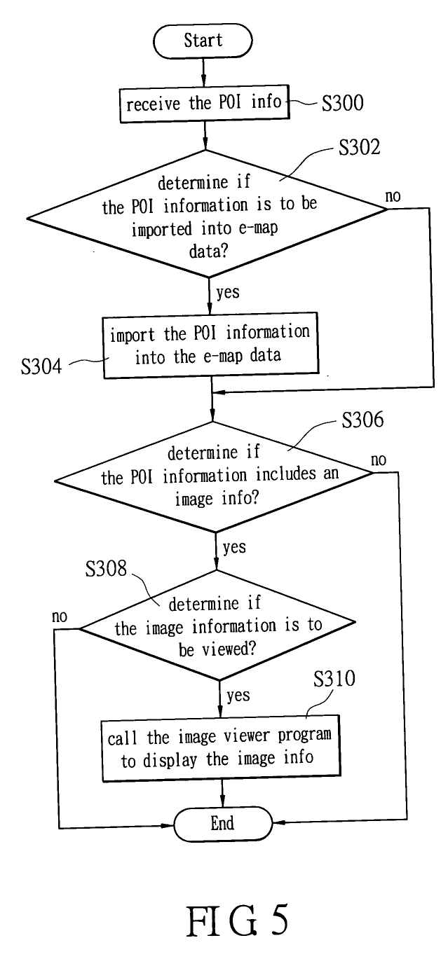

FIG. 5 is a flow chart illustrating how the mobile communication device with e-map data works to receive e-map data. In step S300, point-of-interest (POI) information is received. The POI information is transmitted via SMS/MMS, infrared, Bluetooth or wireless local area network. In step S302, whether the POI information is to be imported into e-map data is determined. The e-map data comprise an electronic map and POI information. This step automatically decides to import the POI information into the e-map data if the POI information conforms to a format and/or if a user has input an importing command. If yes, then the POI information is imported into the e-map data in step 304; if not, then no POI information is imported. In step S306, whether the POI information includes an image information is determined. If yes, then in step S308, whether the image information is to be viewed is determined. In the step of determining if the image information is to be viewed, it is determined if the image viewer program supports the format of the image information and/or whether a user has issued a viewing command. Otherwise, if the POI information does not include image information, then the integrated image viewer program proceeds to the next executing step or the user manually selects the next desired step. In this embodiment, the process of receiving the e-map data completely stops. In the step of determining if the image information is to be viewed; if yes, then the image viewer program is called to display the image information in step S310. Otherwise, the integrated image viewer program proceeds to the next executing step or the user manually selects the next desired step. In this embodiment, the process of receiving the e-map data completely stops.

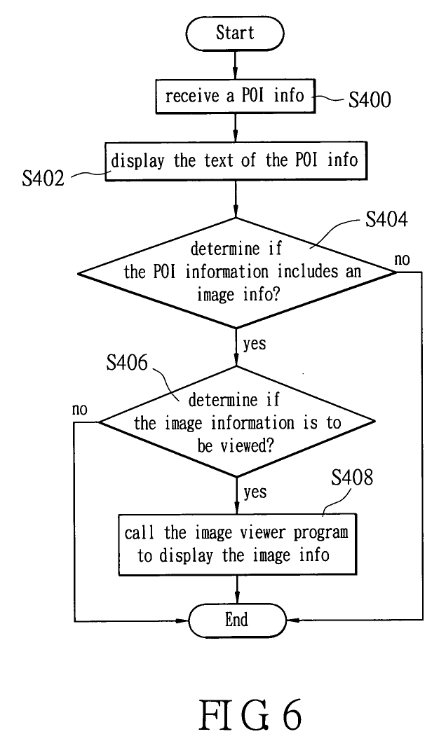

FIG. 6 is a flow chart illustrating how the mobile communication device having no integrated e-map data works to receive e-map data. In step S400, POI information is received. The POI information is transmitted via SMS/MMS, infrared, Bluetooth or wireless local area network. In step S402, the text of the POI information is displayed. In step S404, whether the POI information includes an image information is determined. If yes, then whether the image information is to be viewed is determined in step S406. Otherwise, if the POI information does not include image information, the integrated image viewer program proceeds to the next executing step or the user manually selects the next desired step. In this embodiment, the process of receiving the e-map data completely stops. In the step of determining if the image information is to be viewed, if yes, the image viewer program is called to display the image information in step S408. Otherwise, the integrated image viewer program proceeds to the next executing step or the user manually selects the next desired step. In this embodiment, the process of receiving the e-map data completely stops.

The present invention provides a mobile phone using basic functions with integrated electronic map and wireless transmission technology to display user specified POI information on the mobile phone screen or to transfer to other mobile phone, in which the other mobile phone has (or hasn't) integrated electronic map.

The advantages of the present invention are:
1. A real-time query is enabled by using a mobile phone integrated electronic map and a POI database.
2. A user can choose to import the text part of the query result from the POI database into a personal phone book for later use.
3. The query result can be an image (electronic map) or text (phone number, address, longitude or latitude data in the POI info), which can be transmitted to another mobile phone via wireless transmission scheme such as SMS/MMS, infrared, Bluetooth, or wireless local area network to facilitate data sharing.

Although the present invention has been described with one of the preferred embodiments shown accompanying with the drawings, one of ordinary skilled in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An application method for a mobile communication device with a e-map data, comprising the following steps:
displaying a data display interface;
receiving query data;
calling an e-map data query engine unit to request said e-map data by using said query data;
returning a query result and displaying the query result on a human-machine data processing interface unit; and
executing a command input by a user through said human-machine data processing interface unit.

2. The application method of claim 1, wherein said data display interface is a phone book interface or a map display interface.

3. The application method of claim 2, further comprising a step of:
determining if an end-of-search signal is received, wherein if said end-of-search signal is received, the application method returns to the displaying step, and if said end-of-search signal is not received, the application method returns to the receiving step.

4. The application method of claim 2, wherein said query data are input by a user through said human-machine data processing interface unit.

5. The application method of claim 2, wherein said e-map data query engine unit comprises an electronic map engine and a point-of-interest information engine.

6. The application method of claim 2, wherein said query result is a text, point-of-interest information, a map graph, or a combination thereof.

7. The application method of claim 2, wherein said command comprises importing said text or said point-of-interest information into a personal phone book, transferring said text or said point-of-interest information to a dialing unit for dialing, and transmitting said query result to other mobile communication devices through a wireless communication scheme, or a combination thereof.

8. The application method of claim 7, wherein said personal phone book is included in said human-machine data processing interface unit.

9. The application method of claim 7, wherein said wireless communication scheme is SMS/MMS, infrared, Bluetooth or wireless local area network.

10. A method of receiving e-map data for a mobile communication device with an e-map data, comprising the following steps:
receiving a point-of-interest information through wireless transmission scheme;
displaying a text of said point-of-interest information; and
determining whether said point-of-interest information is to be imported into said e-map data, wherein if yes, said point-of-interest information is imported into said e-map data.

11. The method of claim 10, wherein the determining step comprises determining if a user has input an importing command.

12. The method of claim 10, wherein said e-map data comprises an electronic map and point-of-interest information.

13. The method of claim 12, wherein said wireless transmission scheme is SMS/MMS, infrared, Bluetooth or wireless local area network.

14. The method of claim 12, further comprising the step of determining if said point-of-interest information includes image information.

15. The method of claim 14, further comprising the step of determining whether said image information is to be viewed or not.

16. A mobile communication device, comprising:
e-map data;
an e-map data query engine unit for receiving query data to search said e-map data; and
a human-machine data processing interface unit for connecting said e-map data query engine unit to display a query result.

17. The mobile communication device of claim 16, further comprising a wireless transmission interface unit connecting to said e-map data query engine unit.

18. The mobile communication device of claim 16, wherein said human-machine data processing interface unit comprises a map display interface, a point-of-interest information search interface and a phone book interface.

19. The mobile communication device of claim 16, further comprising a dialing unit connecting to said map display interface, said point-of-interest information search interface and said phone book interface.
